(19) United States
(12) Patent Application Publication
(10) Pub. No.: US 2014/0108233 A1
(43) Pub. Date: Apr. 17, 2014

(54) SOCIAL PAYMENT METHOD AND APPARATUS

(71) Applicant: MASTERCARD INTERNATIONAL INC., Purchase, NY (US)

(72) Inventors: Seçkin Yilgören, Istanbul (TR); Erdem Çakar, Istanbul (TR); Brian DuCharme, New York, NY (US); Asya Vitanova, Brussels (BE); Nisrine Labcir, Ixelles (BE); James George Gallagher, Co. Dublin (IE); Karl Ingram, Co. Dublin (IE); Stephen Whitney, Co. Dublin (IE)

(73) Assignee: MASTERCARD INTERNATIONAL INC., Purchase, NY (US)

(21) Appl. No.: 13/651,104

(22) Filed: Oct. 12, 2012

(51) Int. Cl. G06Q 20/10

(52) U.S. Cl. CPC G06Q 20/10
USPC 705/39

(57) ABSTRACT

A system, method, and computer-readable storage medium configured to facilitate electronic payments through social networks.

### BACKGROUND

1. Field of the Invention

Aspects of the disclosure relate in general to social networks. Aspects include an apparatus, system, method and computer-readable storage medium to facilitate electronic payments through social networks.

2. Description of the Related Art

A social networking service is an online service that focuses on facilitating the building of social relations among people. The service allows individuals to for example, share interests, activities, backgrounds, or real-life connections. A social network service consists of a representation of each user (often referred to as a “profile”) and social links.

Most social networking services are web-based and provide means for users to interact over the Internet, such as e-mail and instant messaging. Social networking sites allow users to share ideas, activities, events, and interests within their individual networks.

In addition to individuals, vendors are increasingly using social networking services to market their goods and services. In exchange for having consumers “like” or “friend” them in a social network, vendors may offer free samples or discount codes.

### SUMMARY

Embodiments include a system, device, method and computer-readable medium to enable electronic payments via a social networking service. Embodiments allow for payment requests, payments, and receipt of payments via the social networking service.

### BRIEF DESCRIPTION OF THE DRAWINGS

FIG. 1 illustrates an embodiment of a system configured to enable electronic payments via a social networking service.

FIG. 2 depicts an apparatus embodiment configured to enable electronic payments via a social networking service.

FIGS. 3A-B flowchart a method embodiment to enable a payment via a social networking service.

FIGS. 4A-B flowchart a method embodiment to request a payment via a social networking service.

FIGS. 5A-B flowchart a method embodiment to receive a payment via a social networking service.

### DETAILED DESCRIPTION

One aspect of the disclosure includes the realization that social networks can also be used to facilitate financial transactions between individuals and other entities.

In another aspect of the disclosure, a social network enables payment services that may include making payments, requesting payments, or receiving payments via the social network. Users may then post feedback and comments on the payment process to the social network.

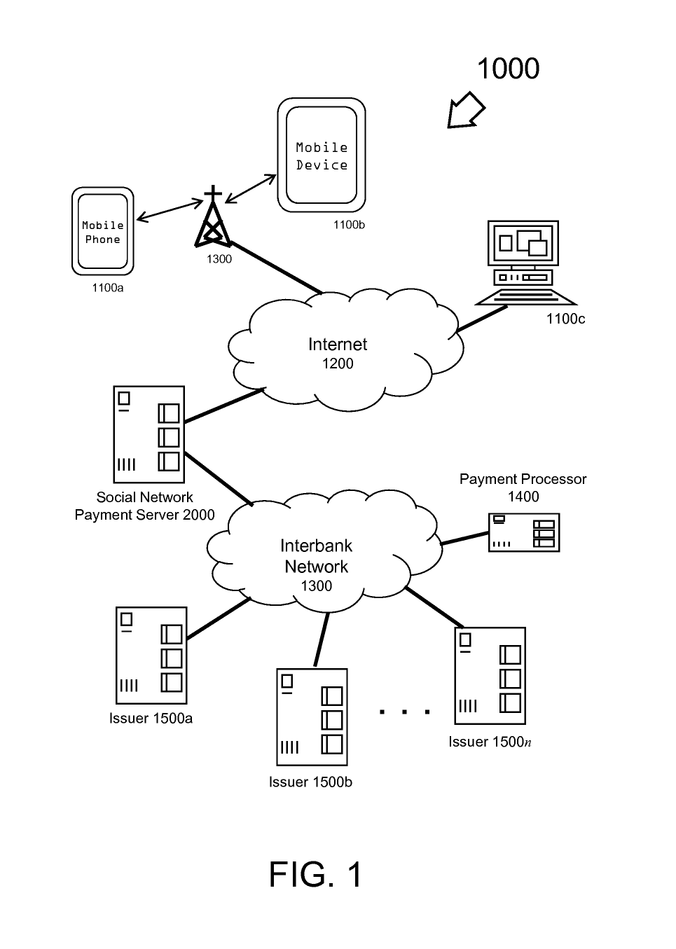

FIG. 1 illustrates an embodiment of a system 1000 configured to enable payment via a social networking service, constructed and operative in accordance with an embodiment of the present disclosure. System 1000 includes consumers using a plurality of computing devices 1100a-e to connect to a social network payment server 2000 via a data network 1200, such as the Internet. Details and example uses of social network payment server 2000 are discussed below.

In some embodiments, consumers may use mobile computing devices 1100d-e and connect to social network payment server 2000 via a wireless data network 1300 capable of connecting to the Internet. It is understood that wireless data network 1300 may be a wireless data provider such as a cellular telephone network, wireless local area network (WLAN or “WiFi networks”), satellite data networks, and the like. Mobile computing devices 1100 include mobile devices such as mobile telephones, tablet computers, laptop computers, “ultra books” or other portable computing device known in the art capable of communicating to social network payment server 2000.

As shown in FIG. 1, social network payment server 2000 may be connected to payment processor 1400 and issuers 1500a-n via an interbank network. Social network payment server 2000 electronically implements a social networking service.

Payment processor 1400 is a payment network capable of processing payments electronically. Example payment processors 1400 include MasterCard International Incorporated.

Issuers 1500a-n include any banks and other entities that issue payment cards.

An interbank network 1300 is a computer network that connects different banking institutions. For example, an Automated Teller Machine (ATM) consortium network is an interbank network.

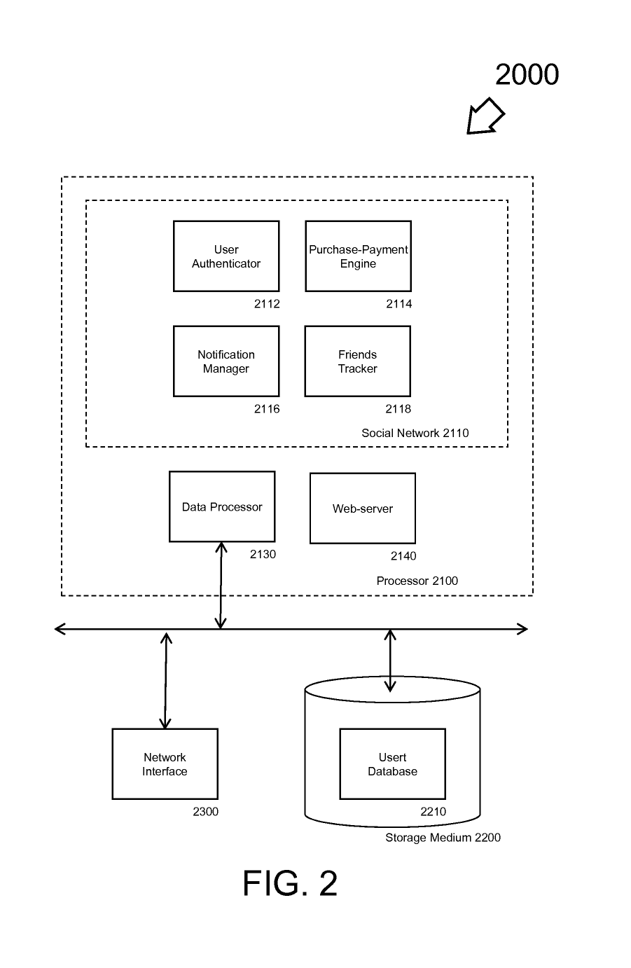

Embodiments will now be disclosed with reference to a block diagram of an exemplary social network payment server 2000 of FIG. 2, constructed and operative in accordance with an embodiment of the present disclosure. Social network payment server 2000 is configured to merge balances of payment cards.

Social network payment server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

As shown in FIG. 2, processor 2100 is functionally comprised of a social network 2110, a web-server 2140, and a data processor 2130.

Social network 2110 may further comprise: user authenticator 2112, purchase-payment engine 2114, notification manager 2116, and friends tracker 2118. User authenticator 2112 is an interface that allows users to verify their identity to the social network payment server 2000. Purchase-payment engine 2114 performs payment and purchase transactions to payment cards, checking accounts, electronic wallets or other financial accounts known in the art. Payment cards include debit, credit, and charge cards. Notification manager 2116 enables the social network 2110 to communicate with users. Friends tracker 2118 enables the social network 2110 to associate users within the social network. These structures may be implemented as hardware, firmware, or software instructions and data encoded on a computer readable medium, such as storage media 2200. Further details of these components are described with their relation to method embodiments below.

Data processor 2130 interfaces with storage media 2200 and network interface 2300. The data processor 2130 enables processor 2100 to locate data on, read data from, and write data to, these components.

Web-server 2140 is any computing device configured to deliver web pages or other content across the Internet 1200 via network interface 2300; user devices 1100 may communicate with a social network 2110 via the World-Wide-Web protocol and web-server 2140.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows social network payment server 2000 to communicate with internet 1200, consumer 1100, consumers using mobile payment devices 1100d-e, interbank network 1300, payment processor 1400, and issuers 1500a-n.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 2200 may be remotely located from processor 2100, and be connected to processor 2100 via a network such as a local area network (LAN), a wide area network (WAN), or the Internet 1200.

In addition, as shown in FIG. 2, storage media 2200 may also contain a user database 2210. User database 2210 is configured to store information associating users with payment cards and other financial services accounts. Users may be individuals, businesses, charities, or other entities. For individual user accounts, users may be associated with one or more payment cards.

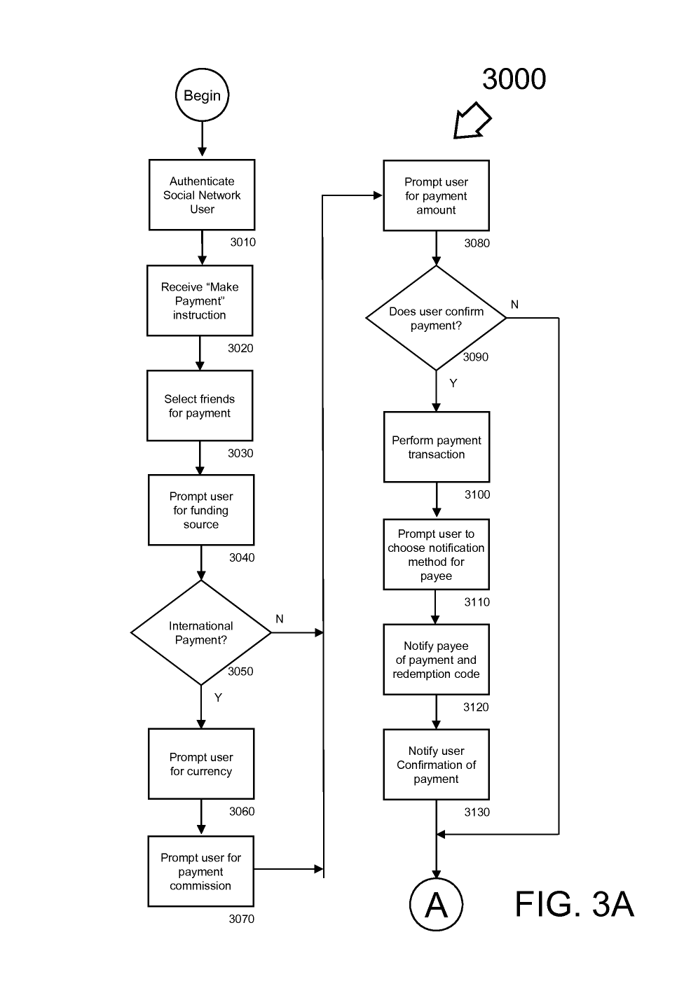

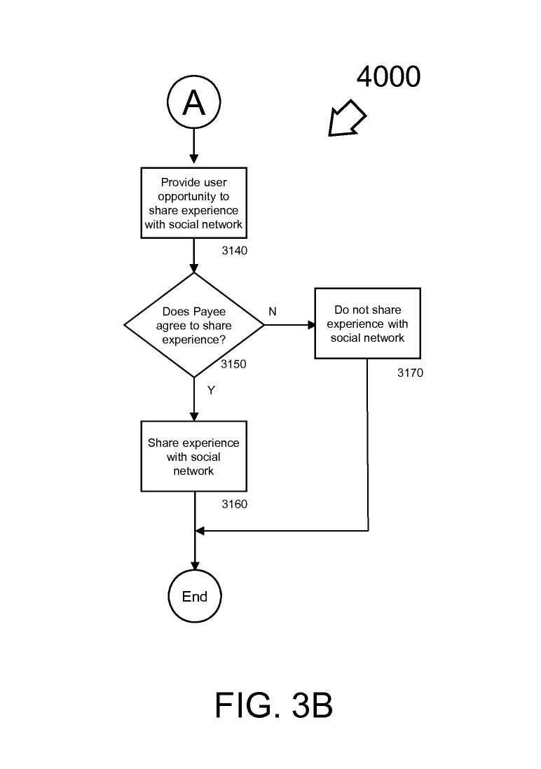

The function of these structures may best be understood with respect to the flowcharts of FIGS. 3-5, as described below.

We now turn our attention to method or process embodiments of the present disclosure, FIGS. 3-5. It is understood by those known in the art that instructions for such method embodiments may be stored on their respective computer-readable memory and executed by their respective processors. It is further understood that users may connect to the social network payment server via a myriad of computing device. For example, the computing device may be a mobile device such as a tablet computer, a mobile phone, or stationary device, such as a desktop computer.

It is further understood that embodiments of the present disclosure may be applied to a variety of financial services accounts, including credit, debit, charge, prepaid cards, checking accounts, savings accounts, trading accounts and electronic wallets (subject to any applicable financial regulatory restrictions and requirements). An electronic wallet is a program or service where users can store and control their online shopping information, like logins, passwords, shipping address and payment card details, in one central place.

FIGS. 3A-B flowchart a method 3000 to enable a payment via a social network payment server 2000, constructed and operative in accordance with an embodiment of the present disclosure.

At block 3010, user authenticator 2112 receives information from user 1100 to authenticate the user against data stored in the user database 2210. Embodiments may authenticate users using any method known in the art including, but not limited to: passwords, cardkeys, optical recognition, fingerprint identification, and facial recognition.

When social network 2110 receives a “make payment” instruction, block 3020, the friends tracker 2118 prompts the user to select the friend (the “payee”) to receive a payment at block 3030. Friends tracker 2118 allows user 1100 to select associates or friends as payees, based on links from user 1100a to other users in user database 2210, block 3020.

The user is prompted to designate a funding source for the payment, block 3040 by purchase-payment engine 2114.

Payments may be made in a variety of different electronic payment methods, including, but not limited to: payment cards, electronic wallets and banking accounts. Each different method has differing types of data associated with it, and this data is stored in the user database 2210. Payment cards include a unique identifier such as a Primary Account Number (PAN). Banking accounts include checking and savings accounts. As described above, an electronic wallet is a program or service where users can store and control their online shopping information. A bank account will include a routing transit number (RTN) and an account number. In the United States, the routing transit number is a nine-digit bank code identifying the financial institution, used to facilitate the sorting bundling and shipment of checks to the account. Outside the United States, such as in Europe, an International Bank Account Number (IBAN) number may be used.

As part of the funding source selection, the funding source may be selected from information stored at user database 2210, and/or the user may be prompted for the information.

At decision block 3050, the social network 2110 determines whether the payment transaction is an international payment transaction. In one embodiment, the international payment transaction determination may be made by comparing the user's country of residency with the payee's residence country. In another embodiment, the user may be prompted for the information.

If the payment is not an international transaction, flow continues at block 3080; otherwise, the user may be prompted for the international currency, block 3060.

In some embodiments, the purchase-payment engine 2114 determines the currency for international transactions by the payee's country of residence. In one embodiment, the purchase-payment engine 2114 is able to look up the conversion rate and presents this to the user. Additionally, user are prompted for how they want the currency commission to be paid, block 3070. Generally, exchange commissions may be paid by the sender, or deducted from the amount sent to the payee.

At block 3080, the user is prompted for an amount to be paid.

At decision block 3090, the social network 2110 presents a summary of the payment transaction to the user and asks the user to confirm the payment. If the user denies the payment transaction, the transaction is cancelled and process 3000 continues at block 3140.

If the user confirms the transaction, the purchase-payment engine 2114 performs the payment transaction, block 3100, preparing to credit the payee's account by the amount to be paid, minus any transaction fees.

The user is prompted to choose a notification method, to inform the payee about the impending payment, block 3110. The payee is notified about the pending payment and presented a redemption code to redeem the payment by notification manager 2116, block 3120. The redemption code may be generated by the purchase-payment engine 2114. In one embodiment, the redemption code is a unique code related to the transaction.

The user 1100 is notified when the payment is redeemed by the payee, block 3130. The notification may occur via the social network, an electronic mail message, a short-message service (SMS) message, text message, automated telephone call or any other electronic communication known in the art.

At block 3140, the user 1100 is invited to share their payment experience with the social network 2110. If the payee agrees to share the experience, as determined at decision block 3150, the experience is shared at block 3160. Otherwise, the information is not shared, block 3170, and the process 3000 ends.

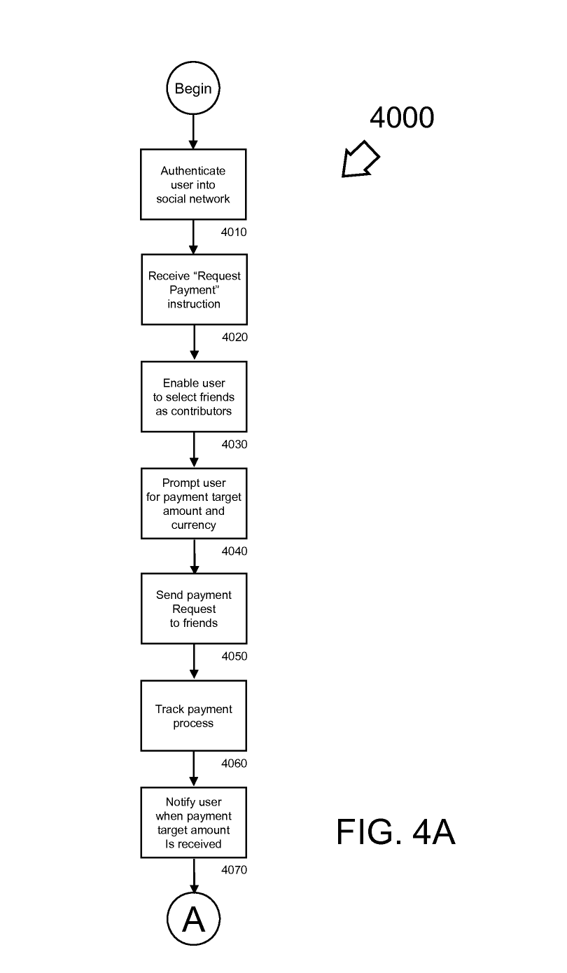

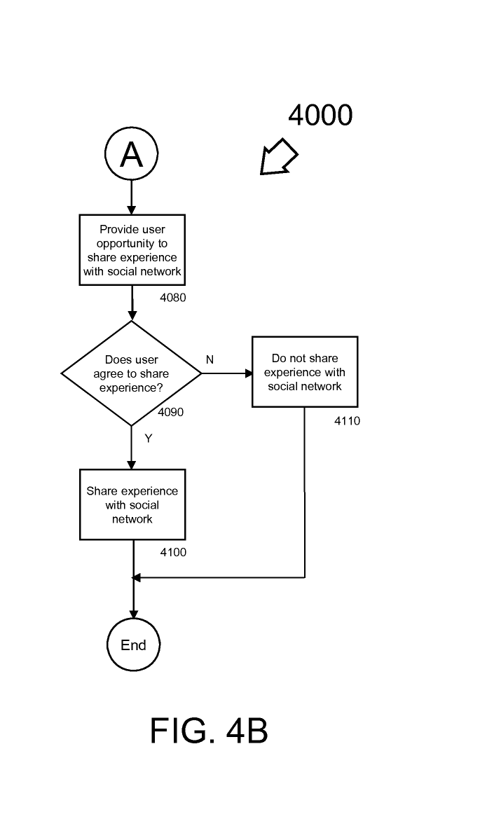

FIGS. 4A-B flowchart a method 4000 to request a payment via a social networking service, constructed and operative in accordance with an embodiment of the present disclosure. In such an embodiment, the user requests a friend or group of friends to make a payment to the user. This method 4000 may be used to raise funds from a group of friends for a specific social event, charity, activity or the like.

At block 4010, user authenticator 2112 receives information from user 1100 to authenticate the user against data stored in the user database 2210. As mentioned above, user authenticator 2112 embodiments may authenticate users using any method known in the art including, but not limited to: passwords, cardkeys, optical recognition, fingerprint identification, and facial recognition.

When social network 2110 receives a “request payment” instruction, block 4020, the friends tracker 2118 prompts the user to designate a friend (a “payor”) or group of friends that will make the payment at block 4030. Friends tracker 2118 allows user 1100 to select associates or friends as payees, based on links from user 1100a to other users in user database 2210.

The user is prompted to designate the amount and currency for the payment, block 4040. In some embodiments, the amount and currency may be a “target” amount that a group is trying to raise.

Social network 2110 tracks the payment transaction or transactions (when multiple payors are contributing), block 4060. When the payment is completed or the target goal for funds is completed or exceeded, notification manager 2116 sends a notification to the user to report that the payor has made the payment, block 4070. The notification may occur via a method predetermined by the user. In some instances, the notification occurs via the social network, an electronic mail message, a short-message service (SMS) message, text message, automated telephone call or other electronic communication known in the art.

At block 4080, the user 1100 is invited to share their payment experience with the social network 2110. If the payee agrees to share the experience, as determined at decision block 4090, the experience is shared at block 4100. Otherwise, the information is not shared, block 4110, and the process 4000 ends.

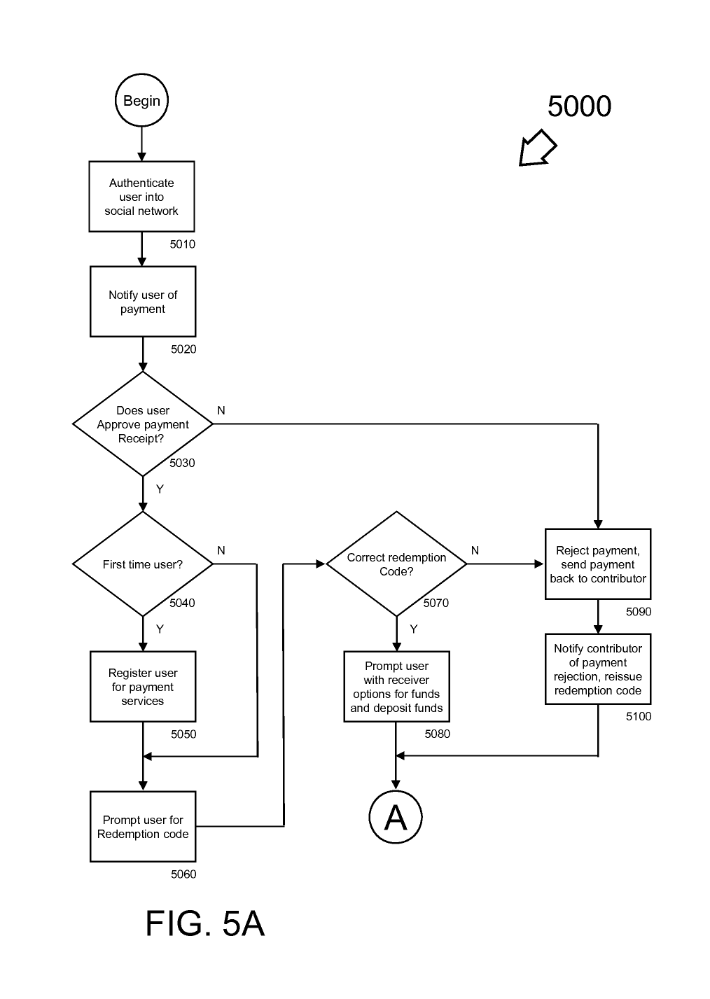

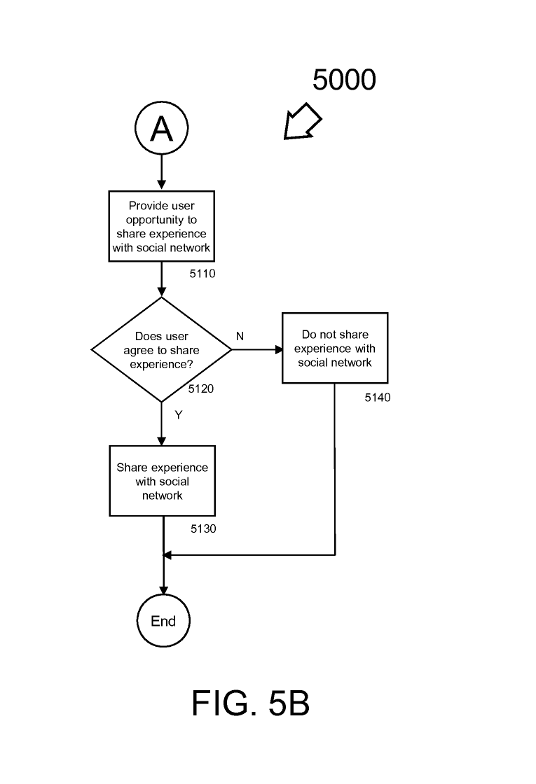

FIGS. 5A-B flowchart a method embodiment 5000 to receive a payment via a social networking service, constructed and operative in accordance with an embodiment of the present disclosure. It is understood by those familiar with the art that the payment received may be from a payment method 3000.

At block 5010, user authenticator 2112 receives information from user 1100 to authenticate the user against data stored in the user database 2210. Similar to the processes out lined above, user authenticator 2112 may authenticate users using any method known in the art including, but not limited to: passwords, cardkeys, optical recognition, fingerprint identification, and facial recognition.

Notification manager 2116 informs the user of payment that has been received, along with a redemption code for the payment, block 5020.

If the user approves the payment receipt, as determined at decision block 5030, the process flow continues at block 5040; otherwise, if the payment is not approved, the process continues at block 5090.

At decision block 5040, social network 2110 determines whether the user is a first time user for the payment process. If not, the process flow continues at block 5060. If the user is a firs time user, they are registered for the payment services, block 5050. The payment registration may include a user registering the appropriate account to receive payment, such as a credit to a payment card, or other financial account.

At block 5060, social network 2110 prompts the user for the provided redemption code, found in the notification from block 5020. Note that some embodiments will prompt the user multiple times if a redemption code is entered incorrectly. These embodiments may also invalidate a redemption code if the code is entered incorrectly more than a predetermined number of times. For example, the user may enter the code three times, and if all three attempts are unsuccessful, the redemption code is invalidated. If the redemption code is incorrect, flow continues at block 5090. If the redemption code is correct, the user is prompted for options on how to receive the funds and the funds are deposited, block 5080. The process flow continues at block 5110.

At block 5090, the user has either disapproved the receipt of the funds (from decision block 5030) or the redemption code is incorrect (from decision block 5070). At this time, the payment is rejected, and the payment is sent back to the contributor/payor. The contributor is notified of the payment rejection, block 5100. In some embodiments, a new redemption code is automatically reissued and sent to payee.

At block 51100, the user 1100 is invited to share their payment experience with the social network 2110. If the payee agrees to share the experience, as determined at decision block 51200, the experience is shared at block 51300. Otherwise, the information is not shared, block 51400, and the process 5000 ends.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

1. A social networking service payment method comprising:
receiving a payment instruction from a user via a network interface;
prompting the user to designate a friend to receive a payment;
prompting the user to designate a funding source for the payment;
prompting the user for an amount of the payment;
generating a redemption code for the payment with a processor;
notifying the friend of the payment and the redemption code via the network interface.

2. The social networking service payment method of claim 1, further comprising:
prompting the user to share the user's payment experience.

3. The social networking service payment method of claim 2, further comprising:
determining a currency conversion for the payment when the payment is an international financial transaction.

4. A social networking apparatus comprising:
a network interface configured to receive a payment instruction from a user;
a user database encoded on a non-transitory computer readable medium, the database containing a user profile record, the user profile record configured to be associated with a plurality of friends' user profiles and configured to be associated with a plurality of funding sources;
a processor, coupled to the network interface, configured to prompt the user to designate a friend to receive a payment, prompt the user to designate a funding source for the payment, prompt the user for an amount of the payment, and generate a redemption code for the payment;
wherein the network interface is further configured to notify the friend of the payment and the redemption code.

5. The social networking apparatus of claim 4, wherein the processor is further configured to prompt the user to share the user's payment experience.

6. The social networking apparatus of claim 5, wherein the processor is further configured to prompt the user to share the user's payment experience determine a currency conversion for the payment when the payment is an international financial transaction.

7. A non-transitory computer readable medium encoded with data and instructions, that when executed by a computer causes the computer to:
receive a payment instruction from a user via a network interface;
prompt the user to designate a friend to receive a payment;
prompt the user to designate a funding source for the payment;
prompt the user for an amount of the payment;
generate a redemption code for the payment with a processor;
notify the friend of the payment and the redemption code via the network interface.

8. The non-transitory computer readable medium of claim 7, further causing the computer to:
prompt the user to share the user's payment experience.

9. The non-transitory computer readable medium of claim 8, further causing the computer to:
determine a currency conversion for the payment when the payment is an international financial transaction.

10. A social networking service payment request method comprising:
receiving a payment request instruction from a user via a network interface;
prompting the user to designate a plurality of friends to receive the payment request;
prompting the user for an aggregate total target amount of the payment request;
notifying the plurality of friends of the payment request via the network interface; and
alerting the user when the aggregate total target amount is received or exceeded from the plurality of friends.

11. The social networking service payment method of claim 10, further comprising:
prompting the user to share the user's payment experience.

12. A social networking apparatus comprising:
a network interface configured to receive a payment request instruction from a user;
a user database encoded on a non-transitory computer readable medium, the database containing a user profile record, the user profile record configured to be associated with a plurality of friends' user profiles;
a processor, coupled to the network interface, configured to prompt the user to designate a plurality of friends from the associated plurality of friends' user profiles to receive the payment request, to prompt the user for an aggregate total target amount of the payment request;
wherein the network interface is further configured to notify the plurality of friends of the payment request via the network interface, and to alert the user when the aggregate total target amount is received or exceeded from the plurality of friends.

13. The social networking apparatus of claim 12, wherein the processor is further configured to prompt the user to share the user's payment experience.

14. A non-transitory computer readable medium encoded with data and instructions, that when executed by a computer causes the computer to:
receive a payment request instruction from a user via a network interface;
prompt the user to designate a plurality of friends to receive the payment request;
prompt the user for an aggregate total target amount of the payment request;
notify the plurality of friends of the payment request via the network interface; and
alert the user when the target amount is received or exceeded from the plurality of friends.

15. The non-transitory computer readable medium of claim 14, further causing the computer to:
prompt the user to share the user's payment experience.

16. A social networking service payment method comprising:
notifying a user of a payment and a redemption code via the network interface;
prompting the user for the redemption code;
prompting the user for receiver options for the payment;
depositing the payment according to the receiver options chosen by the user.

17. The social networking service payment method of claim 16, further comprising:
prompting the user to share the user's payment experience.

18. A social networking apparatus comprising:
a network interface configured to notify a user of a payment and a redemption code;
a user database encoded on a non-transitory computer readable medium, the database containing a user profile record, the user profile record configured to be associated with a plurality of financial accounts;
a processor, coupled to the network interface, configured to prompt the user for the redemption code, prompt the user for receiver options for the payment from the plurality of financial accounts, and depositing the payment according to the receiver options chosen by the user.

19. The social networking apparatus of claim 18, further comprising:
prompting the user to share the user's payment experience.

20. A non-transitory computer readable medium encoded with data and instructions, that when executed by a computer causes the computer to:
prompt the user for the redemption code;
prompt the user for receiver options for the payment;
deposit the payment according to the receiver options chosen by the user.

21. The non-transitory computer readable medium of claim 20, further causing the computer to:
prompt the user to share the user's payment experience.
